(19) United States
(12) Patent Application Publication
(10) Pub. No.: US 2002/0136346 A1
(43) Pub. Date: Sep. 26, 2002

(54) Fuel element and gas coolant nuclear reactor using same

(76) Inventors: Patrick Aujollet, Pertuis (FR); Jacques Porta, Rians (FR); Stephano Baldi, Torino (IT)

Correspondence Address: BURNS DOANE SWECKER & MATHIS L L P, POST OFFICE BOX 1404, ALEXANDRIA, VA, 22313-1404, US

(21) Appl. No.: 10/031,632

(22) PCT Filed: Jun. 20, 2001
(86) PCT No.: PCT/FR01/01928

(30) Foreign Application Priority Data
Jun. 21, 2000 (FR) 00/07929
Jun. 21, 2000 (FR) 00/07929
Jun. 21, 2000 (FR) 00/07929
Jun. 21, 2000 (FR) 00/07929

(51) Int. Cl. G21C 3/56; G21C 19/28

(52) U.S. Cl. 376/383

(57) ABSTRACT

Fuel element and gas-cooled nuclear reactor using this type of fuel elements.

A fuel element (10) designed for use in a gas- cooled nuclear reactor comprises an assembly of adjacent fuel plates (12a, 12b), cooperating together to define flow channels (14) for the gas coolant. The fuel plates (12a, 12b) are composed of elementary fissile particles, preferably uncoated, embedded in a metallic matrix. A metallic coating may be applied to the two faces of each plate (12a, 12b).

### TECHNICAL DOMAIN

The invention relates mainly to a fuel element designed for use in the core of a nuclear reactor cooled by a gas coolant.

The invention also relates to a gas-cooled nuclear reactor with a core composed of this type of fuel elements.

In particular, a nuclear reactor according to the invention may be used to consume depleted uranium.

### STATE OF THE ART

Most nuclear reactors in operation use nuclear fuel conditioned in the form of pellets stacked in leak tight metallic cladding. The cladding with the nuclear fuel pellets contained in it forms the fuel rods. Fuel rods are grouped into bundles by a rigid framework to form fuel assemblies. A similar layout is usually planned for future nuclear reactors.

A disadvantage of this conventional means of conditioning the nuclear fuel is that it limits the amount of heat that can be dissipated per unit volume of the reactor core when a gas coolant is used. The heat dissipated by nuclear fuel pellet is transmitted to the cooling fluid circulating between the rods by the gas contained in the space separating the pellets from the cladding, and then by the cladding itself. Furthermore, the contact surface area or the heat exchange surface area between conventional fuel rods and the cooling fluid is relatively small.

Furthermore, part of the length in each conventional fuel rod is reserved for devices to immobilize the pellets and for expansion of gas caused by nuclear fission. Consequently, each fuel rod will only generate heat over part of its length. The result is that the heat exchange surface area between the rods and the cooling fluid is only used for the useful volume of the core, in other words the core volume within which heat is effectively generated by the nuclear fuel. This is how the heat exchange area per useful cubic meter of the core is defined.

For example, considering the case of a nuclear reactor core formed of conventional fuel assemblies composed of 8 mm diameter rods laid out in a triangular network and with a c/c distance equal to 12 mm, the heat exchange surface area per useful cubic meter of the core is less than 202 square meters.

This limitation of the heat exchange surface area per unit volume of the core is in addition to the limitation of the maximum temperature of the fuel material that limits the power density per unit volume, in other words the power output per unit volume of the core.

This limitation is particularly severe for nuclear reactors cooled by a gas coolant. These reactors require a high heat exchange surface area to dissipate the core power during normal operation, or to dissipate the residual power after an emergency shutdown.

This situation makes it necessary to limit the power density per unit volume to relatively low values. This penalizes the neutronic capacities of the reactor core, particularly for a fast neutron reactor. This situation is also penalizing for the cost prices of this type of reactors since the limitation on the power density means that the vessel and reactor building dimensions become very large if a reactor is to be built with an economically attractive total power.

While these conventional nuclear fuel assemblies have been in use, over the last few years studies and experiments have been carried out on fuel elements formed from coated fissile particles agglomerated by a carbonaceous matrix. These fuel elements are intended mainly for use in high temperature nuclear reactors cooled by a cooling gas such as helium.

Coated fissile particles comprise a spherical fissile nucleus coated with several successive layers, particularly including an internal porous layer that can contain fission gasses and can resist inflation of the nucleus, and a layer of silicon carbide SiC forming a leak proof barrier for fission products. These particles are said to be of the “TRISO” type. Their diameter varies between a few hundred microns and a few millimeters, depending on the manufacturing process used.

At the moment there are two types of fuel elements in which coated particles are agglomerated in a different form by a carbonaceous matrix.

In a first type of fuel elements developed in the USA and in France, the coated particles are agglomerated in the form of cylindrical rods that are then inserted in vertical tubular channels provided for this purpose in graphite blocks with a hexagonal cross- section, forming the core of a high temperature gas- cooled reactor. The cylindrical rods are made by agglomerating the coated particles and a matrix based on graphite powder.

In a second type of fuel element developed in Germany, the coated particles are agglomerated in the form of balls compacted in bulk with the same size graphite balls, to form the core of a high temperature gas-cooled reactor. The balls are made by agglomerating the coated particles and a carbonaceous matrix to form the central part of the ball, and coating this central part with an outer layer without any coated particles.

The fuel elements formed of coated particles agglomerated in the form of rods or balls have the important advantage that they are simpler and less expensive than conventional nuclear fuel assemblies made of rod bundles.

However, they also have serious disadvantages.

Thus, these fuel elements can only be used in nuclear reactors with a thermal spectrum, since the coated fissile particles are bound together by graphite, in other words by a neutron moderating or decelerating medium.

Another disadvantage of this type of fuel element is that it is not very suitable for industrial implementation, particularly because individual handling of the elements necessary to periodically renew a fraction of the reactor core is very difficult. Finally, it is impossible to independently control the heat exchange capacity and heat losses, or the geometry of the fuel of the vessel, particularly at high values of the gas coolant velocity.

### PRESENTATION OF THE INVENTION

The main purpose of the invention is a fuel element with an innovative design so that it can be used in a nuclear reactor cooled by a gas coolant, providing significantly higher heat exchange surface area and power density per unit volume than conventional fuel assemblies.

According to the invention, this result is obtained by means of a fuel element for a nuclear reactor core using a gas coolant, the said fuel element being characterised in that it comprises a set of adjacent fuel plates comprising elementary fissile particles embedded in a metallic matrix, the shapes of adjacent fuel plates being such that they cooperate to define a plurality of channels through which the gas coolant can flow.

In this type of fuel element, the fuel plates are assembled by any type of means so that they cooperate to define channels through which the gas coolant flows. The resulting layout is similar to the layout of a conventional heat exchanger. Consequently, all technologies typically used in this type of exchanger can be reused. Thus, fuel elements may be made of plates approximately parallel to each other between which corrugated plates are inserted. Alternatively, all fuel plates in a single element may be corrugated. The geometry of the fuel element may be plane, circular, spiral, etc.

In one preferred embodiment of the invention, the channels through which the gas coolant flows are approximately parallel to each other.

Furthermore, the fuel plates preferably extend over the entire height of the reactor core and the channels are approximately vertical.

According to a first possible arrangement, the cross-sections of the channels are approximately uniform over their entire length.

According to another possible arrangement, the cross-sections of the channels are variable such that, in sequence along the direction of flow of the gas coolant, each of them comprises a convergent entry part and a divergent exit part. With this arrangement, the pressure of the gas coolant can be reduced in the convergent entry part of the channels and consequently cooling of the core can be more efficient because the temperature of the gas coolant is lower than it would be if the cross-sections of the channels were uniform. This arrangement also makes it possible to compress the gas coolant in the exit diffuser under subsonic conditions.

In the preferred embodiment of the invention, the elementary fissile particles are fissile and fertile bodies embedded directly into the metallic matrix. Each plate can then be obtained directly by rolling, or may be co-rolled with metallic coatings formed on each of its faces.

Alternatively, elementary fissile particles are coated fissile and fertile bodies embedded in the metallic matrix. In this case, the fuel plates are obtained directly by rolling.

The elements forming the elementary fissile particles are uranium and/or plutonium and/or thorium. Note that depleted uranium composed mainly of uranium 238 can be consumed with the fuel element according to the invention.

Another purpose of the invention is a nuclear reactor cooled by a gas coolant, the core of which is formed of fuel elements of the type defined above. This type of reactor is characterised particularly by the fact that the neutron flux in the core is essentially a fast neutron flux.

The gas coolant is advantageously carbon dioxide CO₂, helium, air or argon.

Control and instrumentation of this type of reactor can be provided by boron carbide B₄C control devices arranged so that they can be inserted between the fuel elements.

### BRIEF DESCRIPTION OF THE DRAWINGS

We will now describe a preferred embodiment of the invention as a non-restrictive example with reference to the attached drawings, in which:

FIG. 1 is a perspective view showing a fuel element according to a first embodiment of the invention,

FIG. 2 is a sectional view of the fuel element in FIG. 1, on a horizontal plane at a larger scale,

FIG. 3 is a sectional view similar to that in FIG. 2, illustrating an alternative embodiment,

FIG. 4 is a perspective view comparable to FIG. 1, illustrating another embodiment of a fuel element according to the invention, and

FIG. 5 shows the neutron spectrum obtained for an infinite medium by calculation, assuming that fuel elements according to the invention are used to form the core of a nuclear reactor cooled by carbon dioxide CO₂.

### DETAILED DESCRIPTION OF PREFERRED EMBODIMENTS OF THE INVENTION

Elements of the various embodiments described that perform similar functions are denoted by the same numeric references.

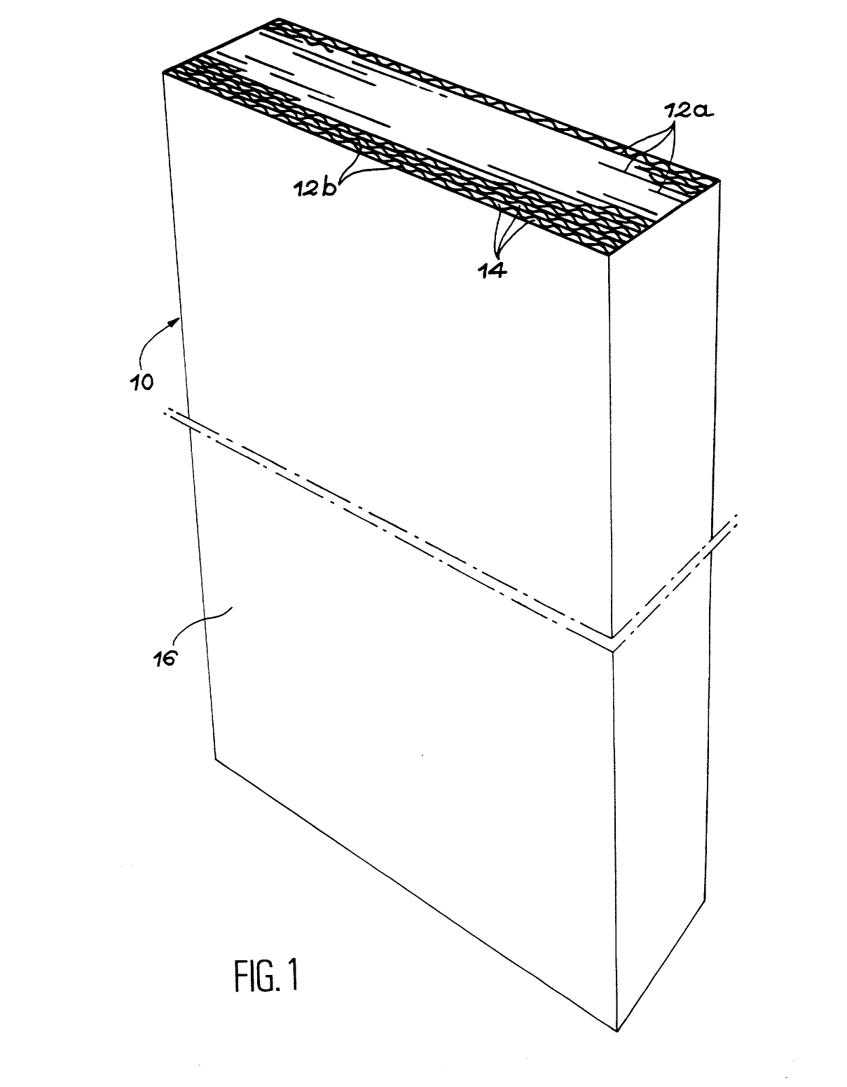

FIG. 1 diagrammatically shows a perspective view of a fuel element 10 conform with a first embodiment of the invention.

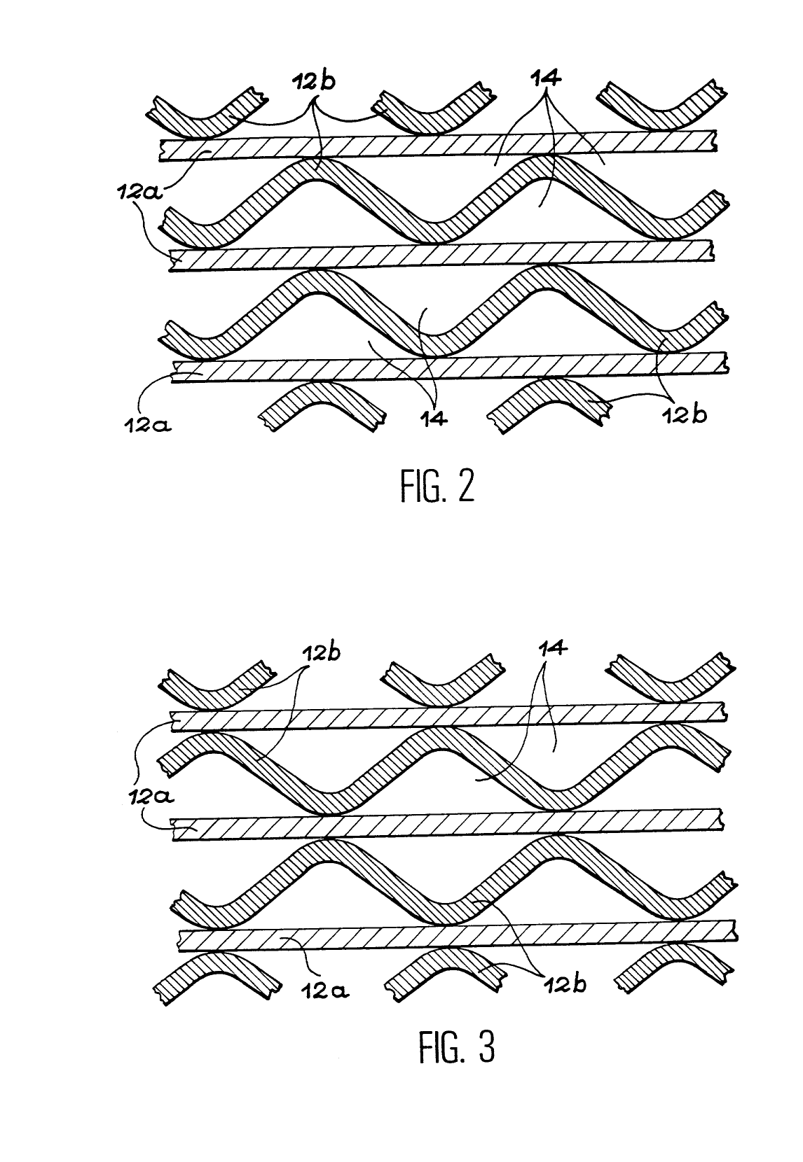

According to one essential characteristic of the invention, the fuel element 10 consists of an assembly of a number of adjacent fuel plates. In the embodiment illustrated in FIGS. 1 and 2, the adjacent fuel elements comprise flat plates 12a parallel to each other and corrugated plates 12b. These flat plates 12a and corrugated plates 12b are arranged alternately, in other words each of the corrugated plates 12b is placed between two flat plates 12a. However, it will be observed that this arrangement is only given as one example of the invention that is in no way restrictive, since the various fuel plates forming the fuel element 10 can be arranged in many other shapes without going outside the framework of the invention, as will be described later.

The expression “fuel plates” means that each of the plates such as 12a and 12b of the fuel element 10 is solid and in itself forms the nuclear fuel, in other words the fissile medium.

Fuel plates such as 12a and 12b are thin plates, in other words plates that are a few millimeters thick. As a non-restrictive example, the thickness of the plates 12a and 12b may be about 2 mm.

Each of the plates such as 12a and 12b is made by rolling or co-rolling a cermet composed of elementary fissile particles embedded in a metallic matrix. In the case of non-flat plates such as corrugated plates 12b, the plate obtained is then shaped, for example in a press.

The elementary fissile particles are approximately spherical with a diameter of the order of a few hundred microns. Each contains a fissile element composed of plutonium and/or uranium.

The metallic matrix is made from a metal such as molybdenum, steel, tungsten, zirconium or Zircaloy (registered trademark).

Since the fuel element 10 is designed to be used in a nuclear reactor cooled by a gas coolant, the fissile bodies contained in the elementary fissile particles are advantageously not coated, in other words these fissile bodies are embedded directly in the metallic matrix without being protected by one or several coatings. Fission gasses released by these particles are then confined by the metallic matrix. In particular, this result can be obtained by rolling an ingot with a higher concentration of fissile particles at its centre than close to its faces.

A metallic coating may be provided on each of the said faces, if this technique for manufacturing plates 12a and 12b cannot guarantee that there is any metal between all elementary fissile particles and the two faces of the plates necessary for confinement of fission gasses. The fuel plates such as 12a and 12b are then made by co-rolling with the above mentioned coatings. In this case, the metal for the coatings is chosen from the same group of materials as the metal from which the matrix is made.

Alternatively, it is also possible to use elementary fissile particles composed of coated fissile bodies, in other words coated with several protection layers, in particular integrating a coat of silicon carbide SiC. In this case there is no need for the presence of a metallic coating on each face of the fuel plate, and the plate can be made directly by rolling and possibly forming.

According to one essential characteristic of the invention, the different fuel plates such as 12a and 12b used in the composition of the fuel element 10 are assembled such that adjacent fuel plates cooperate to define several channels 14 through which the gas coolant is free to flow. The channels 14 are preferably approximately parallel to each other.

In the embodiment illustrated as an example in FIGS. 1 and 2, in other words when the fuel element 10 is composed of the assembly of flat plates 12a and corrugated plates 12b, the cross-sections of the channels 14 are all approximately in the shape of a flattened isosceles triangle.

This arrangement is comparable to the arrangement used in a plate heat exchanger and gives a relatively large heat exchange surface area between the fuel material and the gas coolant. As an illustration, in the case in which plates 12a and 12b are 2 mm thick, the pitch of corrugations of plates 12b is 12 mm and the distance between the median planes of two consecutive flat plates 12a is 10 mm, the heating perimeter for each channel 14 is a equal to 43.8 mm and the heat exchange surface area per unit volume for the entire core is equal to 436/m.

Furthermore, the single block nature of plates such as 12a and 12b is a means of achieving an efficient heat transfer between the fuel material contained in the plates and the gas coolant. Thus, the required objectives are achieved.

More generally, the shapes of the various plates such as 12a and 12b used in the composition of the fuel element 10 according to the invention are chosen so that they give the greatest possible heat exchange surface area between the walls of these plates and the gas coolant, while maintaining a reasonable value of the flow resistance. This results in large values of heat exchange surface areas between the fuel material and the gas coolant per unit volume of the core.

This characteristic, combined with the very good thermal conductivity of cermet fuel plates, has many advantages. Some of these advantages are the possibility of obtaining power densities per unit volume that are satisfactory for the neutronic design of the core and for the sizing of the reactor and the corresponding investments. Furthermore, the described arrangement enables very good thermal behaviour in operation due to the small temperature difference between the fuel material and the gas coolant. In particular, it facilitates operation in natural circulation if normal cooling means such as fans for circulating the cooling gas in the reactor are lost when a shutdown occurs, in order to evacuate the residual power. Finally, the above mentioned arrangement enables a reduction in the accumulated heat in the fuel, in other words a reduction in the fuel temperature which facilitates management of accidental transients.

The different fuel plates such as 12a and 12b used in the composition of the fuel element 10 can be assembled by any appropriate means. Thus, and as illustrated diagrammatically in 1, the fuel plates may be kept in contact with each other by a casing 16 with a rectangular cross-section surrounding all fuel plates on both faces of the stack of plates and on the sides of this stack arranged parallel to the channels 14. Alternatively, the casing 16 may be replaced by two or more support devices surrounding the stack of plates, by a set of bolts or equivalent attachment devices passing through the stack of plates, by gluing or welding adjacent plates, etc.

As illustrated in FIG. 1, the fuel element 10 is designed to be placed vertically in the core of a gas- cooled nuclear reactor. The gas coolant flow channels 14 are then oriented approximately vertically and the coolant circulates in them from bottom to top. Furthermore, the fuel element 10 and the fuel plates such as 12a and 12b that compose it advantageously extend over the entire height of the reactor core.

In the embodiment illustrated as an example in FIGS. 1 and 2, the corrugated plates 12b are all identical and their corrugations are all in line, such that each of the flat plates 12a is alternately in contact with a corrugation of a first corrugated plate 12b located on one side of this flat plate 12a and with a corrugation of a corrugated plate 12b located on the other side of the plate 12a.

FIG. 3 shows a variant of this first embodiment, in which the corrugated plates 12b are regularly offset by one corrugation from one corrugated plate 12b to the next. Consequently, the two faces of each of the flat plates 12a are simultaneously in contact with one corrugation on each of the corrugated plates 12b located on each side of this flat plate. In other words, the consecutive corrugated plates 12b are arranged symmetrically with respect to the median plane of the flat plate 12a placed between them.

As already mentioned, the various fuel plates forming the fuel element 10 can be arranged in many other shapes without going outside the framework of the invention. Thus, the flat plates 12a in the variant shown in FIG. 3 may be eliminated. Furthermore, in the embodiments in FIGS. 1 to 3, the heights of the corrugations of plates 12b may be different and/or be replaced by more complex shapes. Furthermore, in all cases, instead of being in the form of a flat panel, the stack of plates can be wound on itself to form a spiral or circular or other cross-section. In general, all techniques usually used in heat exchangers composed of stacked plates can be transposed to the manufacture of fuel elements 10 conform with the invention.

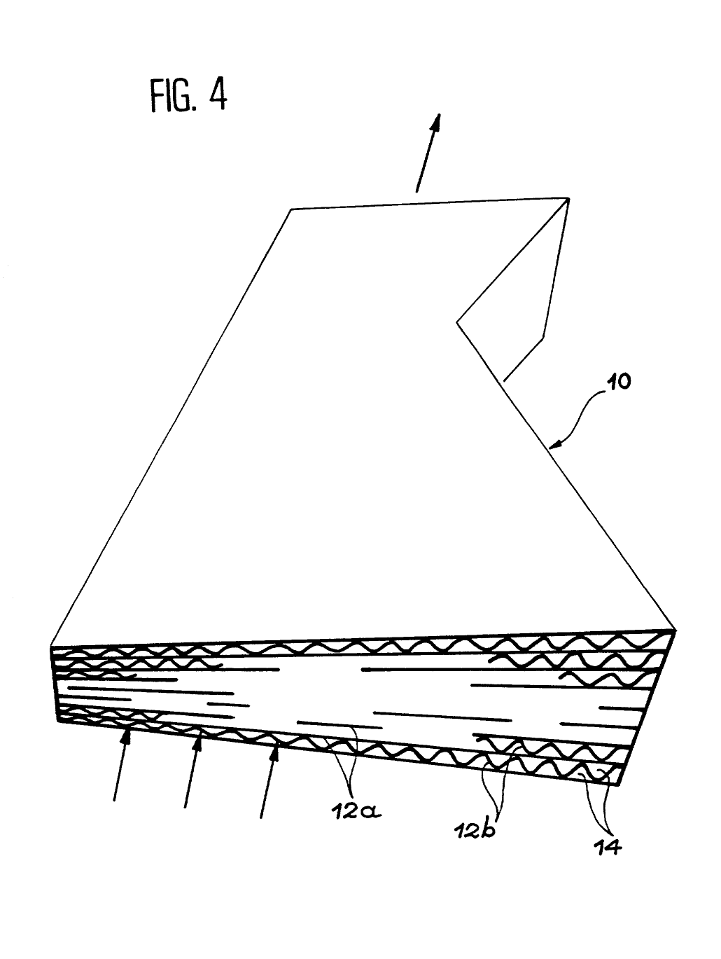

In the above description, the gas coolant flow channels 14 formed between the fuel plates still have an approximately uniform cross-section along their entire length. As illustrated diagrammatically in FIG. 4, the channels 14 may also have a variable cross-section. Thus, each of the channels 14 may comprise, in sequence, a convergent entry part at the bottom and a divergent exit part at the top forming a diffuser, along the direction of flow of the gas coolant inside the fuel element 10, in other words from bottom to top.

This arrangement allows the gas coolant to expand in the convergent entry part of each of the channels. This thus gives more efficient cooling of the reactor core since the temperature of the gas coolant is lower than it would be if the cross-section of the channels 14 were uniform. Furthermore, the gas coolant is compressed in the divergent exit part under subsonic conditions.

As an illustration, the fuel element 10 described above with reference to FIG. 1 is in the form of a panel, for example with dimensions 2 m along the length or height, 47 cm along the width and 7.2 cm along the thickness. This type of panel is obtained by assembling fifteen 2 mm thick fuel plates together, comprising eight flat plates 12a and seven corrugated plates 12b, the spacing between the median planes of two adjacent flat plates 12a being 10 mm and the spacing between two consecutive corrugations of the corrugated plates 12b being also equal to 10 mm.

As already mentioned, this arrangement can give a heat exchange surface area per unit volume equal to 436/m, a hydraulic diameter equal to 5.2 mm and a heating perimeter of 43.8 mm.

The fuel elements 10 according to the invention are designed for use in the core of a gas-cooled nuclear reactor. This gas coolant may be carbon dioxide CO₂, helium, air or pressurized argon.

Simple calculations show that a nuclear reactor cooled by any one of these gases and for which the core is formed of fuel elements 10 according to the invention, can have either a relatively modest power density in the fuel and a very long life core, or a higher power density with a core life that is still satisfactory.

Thus, if carbon dioxide CO₂ is circulated in a core with a cross-section of 9 m² and a height of 2 m, composed of fuel elements 10 of the type described with reference to FIGS. 1 and 2, a very long life is obtained with a velocity at the exit from the core equal to 40 m/s, the entry and exit temperatures being 250° C. and 600° C. respectively. In this case, the exchanged heat power is 1753 MW, which gives an electrical power equal to 720 MWe and an efficiency of the order of 41%. The power density in the fuel is limited to 195 MW/m³ and the relatively low flux per unit area (225 KW/m²) corresponding to the very large exchange surface area gives a temperature difference of less than 65° C. between the centre of the fuel and the coolant gas. The fuel temperature at the hottest point is then less than 700° C. Pressure losses due to the flow of carbon dioxide through the core are about 3 bars.

A significantly higher power density is obtained by using carbon dioxide at a pressure of 40 bars, with a flow velocity at the exit from the core being 50 M/s and the entry and exit temperatures of the carbon dioxide being 250° C. and 800° C. respectively. In this case, the thermal power of the core is 2816 MW corresponding to an electrical power equal to 1240 MWe assuming an efficiency of 43%. The power density in the fuel is equal to 319.11 MW/m³, the temperature in the fuel core is slightly less than 900° C. and the estimated pressure loss passing through the core is slightly less than 4 bars.

The power characteristics (of the order of 1200 MWe) similar to the characteristics of the second case above can be obtained using helium as a coolant at a pressure of 70 bars, the velocity at the exit from the core being 65 m/s and the core entry and exit temperatures being 260° C. and 900° C. In this case, the maximum fuel temperature is less than 1 000° C. and the pressure loss in the core is less than 1 bar.

As already mentioned, the elementary fissile particles contained in the fuel plates such as 12a and 12b are formed of fissile elements such as uranium and/or plutonium, and possibly fertile elements such as thorium.

More precisely, the uranium particles are advantageously in the form of depleted uranium dioxide UO₂ and plutonium dioxide. The expression “depleted uranium dioxide” means particles containing 0.25% of uranium 235 and 99.75% of uranium 238.

Plutonium particles are usually in the form of plutonium dioxide PuO₂ obtained from plutonium originating from an existing pressurized water nuclear reactor. Consequently, it is advantageous to used “2016 quality” plutonium, in other words plutonium with an average composition corresponding to the composition that will be produced in year 2016 by 900 MW electrical pressurized water reactors after three conventional cycles, cooled for three years, reprocessed and fabricated within the next two years.

In a first example composition, each of the fuel plates may comprise 34% of UO₂ particles, 16% of PuO₂ particles and 50% of the metallic matrix, by volume. As already mentioned, the metal from which the matrix is made may be composed particularly of molybdenum, steel, tungsten, zirconium or Zircaloy (registered trademark). Obviously, this composition is simply given as an illustration, and the contents of fissile nuclei will be optimised as a function of the management strategy to be used for the core.

Calculations have been carried out based on this composition, using the APOLLO 2 computer program belonging to the CEA (Commissariat á l'Energie Atomique—Atomic Energy Commission). In these calculations, it was assumed that PuO₂ particles were obtained from 2016 quality plutonium.

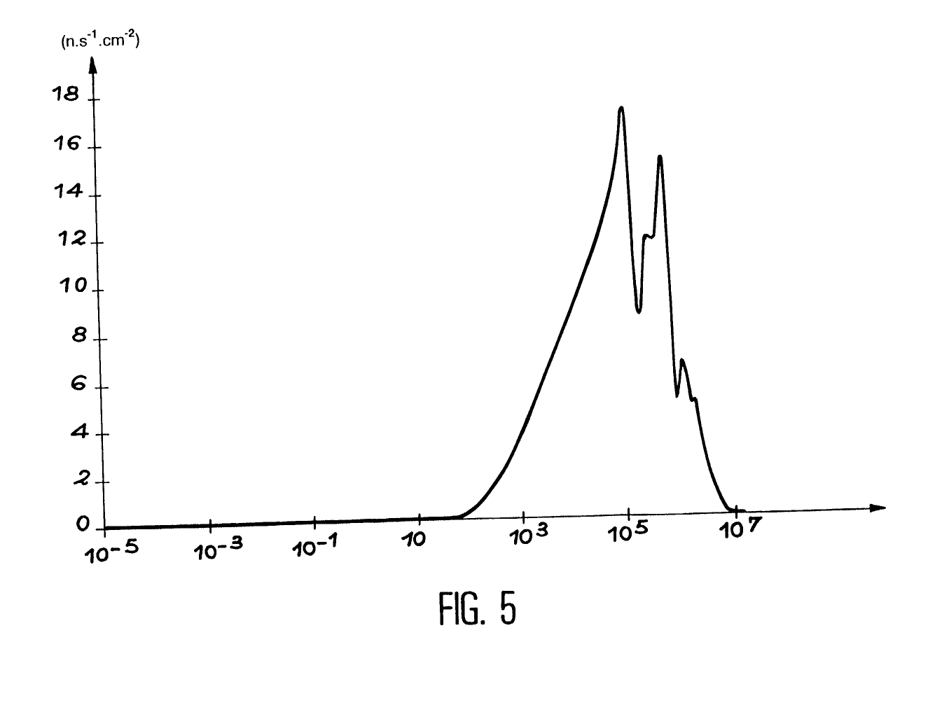

FIG. 5 shows the neutron spectrum obtained by calculation for a nuclear reactor in which the core is formed from fuel elements with a composition conform with the above example. In other words, FIG. 5 shows the distribution of the neutron flux (in n.s⁻¹.cm⁻²) as a function of the energy (in electron volts) in an infinite medium.

This neutron spectrum shows that the neutron flux in the core is essentially a flux of fast neutrons (velocity of the order of 40 000 km/s). In particular, the flux may be considered as being zero below a threshold energy equal to about 50 electron volts and as being almost zero in the uranium 238 resonance range. This characteristic makes it possible to reduce the resonant capture rate of uranium 238 by reducing the production of uranium 239. This characteristic is also a means of increasing the fission rate in the fast domain of uranium 238, while significantly improving the proportion of retarded neutrons β_{eff}.

Furthermore, the neutron calculations show that fuel elements conform with the invention, jointly with the above mentioned composition of assemblies, can give very attractive neutron properties. Thus, the Doppler coefficient is of the order of −1.40 pcm/° C., which would enable an intrinsically safe behaviour of the core following a power excursion causing an increase in the fuel temperature.

Similarly, the proportion of retarded neutrons (β_{eff}) is 364 pcm, which authorizes a good margin of reactor control following an untimely withdrawal of a control device. This favourable phenomenon is accentuated by the strong resistance to fracture and the relatively high melting temperature of some cermets.

Furthermore, the reactivity coefficient is of the order of 1.467 for a new core (infinite medium). Considering the power per unit volume released by the fuel (about 88 W/g of heavy nuclei), it is possible to achieve very long cycles and particularly to achieve a burn-up rate at unloading close to 100 GWd/t (equivalent UO₂).

For the same assumptions, table I contains the initial composition in heavy nuclei of a nuclear reactor core conform with the example considered, and the final composition of this core for a power per unit volume equal to 195 WM/m³ (which corresponds to the first example of a CO₂ reactor defined above) and a burn-up rate at unloading equal to 125 GWd/t. In this table, the values of masses expressed in kg were calculated for the core dimensions given above as an example (18 m³).

TABLE I

| | Initial state | | Final state | | |
|---|---|---|---|---|---|
| | Mass | Vector | Mass | Vector | Variation |
| | (kg) | (%) | (kg) | (%) | in % |
| ²³⁵U | 6.5 | | 0.8 | | (−87.8) |
| ²³⁸U | 2601.0 | | 1862 | | (−28.4) |
| ²³⁸Pu | 33 | 2.74 | 15 | 1.91 | −53.7 |
| ²³⁹Pu | 686 | 56.54 | 330 | 40.97 | −51.9 |
| ²⁴⁰Pu | 317 | 26.04 | 319 | 39.49 | +0.7 |
| ²⁴¹Pu | 91 | 7.41 | 71 | 8.74 | −21.7 |
| ²⁴²Pu | 89 | 7.28 | 72 | 8.89 | −18.9 |
| Puₜₒₜ | 1217 | | 808 | | −33.6 |
| ²⁴¹Am | 8.6 | | 12.0 | | |
| ²⁴³Am | — | | 18.8 | | |
| ²⁴²Cm | — | | 1.6 | | |
| ²⁴⁴Cm | — | | 16.2 | | |
| ²³⁷Np | — | | 0.9 | | |
| ²³⁹Np | — | | 0.8 | | |
| Total | 8.6 | | 51.4 | | +4.17 (% |
| minor | | | | | Pu |
| actinides | | | | | initial) |

Table I shows that the content of fissile plutonium at the end of the cycle is still high (about 50%). This means that an additional reprocessing of plutonium would be possible to obtain a load modulated by the use of an enriched UOX type support and to enable additional use of the plutonium.

Furthermore, although the consumption of plutonium is not the main objective of the invention, it is worth mentioning that the consumed fraction (34%) is greater than for a pressurized water reactor with 30% MOX type fuels, which is limited to about 25%.

Note also that the initial fuel composition may be optimised to improve the consumption of plutonium. However, this type of fuel has the main advantage that it is a large consumer of uranium 238 (reduction of about 30%). This gives a significant economic value to this fuel material that is available in very large quantities.

A gas-cooled nuclear reactor in which the core is composed of fuel elements according to the invention is controlled by inserting boron carbide plates between the fuel elements. Considering the fast spectrum existing in the reactor core, absorptions of heavy isotopes are low and make a very limited individual contribution to the neutronic balance. On the other hand, boron has a very high local absorption rate and is therefore very efficient. In this energy range, its effective cross-sections are of the same order of magnitude as the fuel isotopes, but its concentration is more than 50 times higher. Consequently, inserting a boron carbide plate for each fuel element is sufficient to guarantee a multiplication factor (infinite k) with a value of less than 0.925.

Calculations have also been carried out based on a fuel composition with half the plutonium content of the previous example. This assumption is intended to reduce constraints related to the production of fuel elements with a high plutonium content.

These calculations show that attractive cycle lengths (about three times 18 months) are obtained. Furthermore, since the initial reactivity is lower, this fuel can be controlled more easily. The lower quantity of plutonium and the higher quantity of uranium 238 give a better Doppler coefficient and a better ratio of retarded neutrons. Furthermore, the consumption of uranium 238 is lower than in the previous case and the variation of plutonium 239 is almost zero.

Other calculations were carried out in the two examples of fuel compositions mentioned above, assuming that the power per unit volume is 319 MW/m³ (which corresponds to the second example of a reactor cooled with CO₂ given above).

In both cases, the increased specific power leads to a reduction in the cycle length. However, the cycle obtained is still very interesting. Thus, three cycles lasting about 30 months are obtained for a fuel containing 8% by volume of plutonium oxide, or three 12-month cycles can be obtained using a fuel containing 5% by volume of plutonium oxide.

Furthermore, the increase in power has almost no effect on the percentages of plutonium and uranium consumed when the plutonium content is high. However, the production of minor actinides is slightly lower when the power is increased.

In the case of a fuel with a low plutonium content, the consumption of uranium 238 and plutonium 239 is much more efficient when the power per unit volume is higher.

Obviously, fuel elements conform with the invention may be used in parallelepiped-shaped or cylindrical-shaped cores, or in cores with other shapes. As already mentioned, the shape of each fuel element may be different from the shape described particularly with reference to FIG. 1.

1. Fuel element for a nuclear reactor core with a gas coolant, the said fuel element comprising a set of fuel plates adjacent to each other comprising elementary fissile particles embedded in a metallic matrix, the shapes of the adjacent fuel plates cooperating to define a plurality of gas coolant flow channels.

2. Fuel element according to claim 1, in which the gas coolant flow channels are approximately parallel to each other.

3. Fuel element according to claim 1, in which the said fuel plates extend over the entire height of the reactor core and the said channels are approximately in the vertical direction.

4. Fuel element according to claim 1, in which the channels have approximately uniform cross-sections over their entire length.

5. Fuel element according to claim 1, in which the cross-sections of the channels vary such that each of the said channels comprises a convergent entry part and a divergent exit part, along the direction of flow of the gas coolant.

6. Fuel element according to claim 1, in which the elementary fissile particles are fissile and fertile bodies embedded directly in the metallic matrix.

7. Fuel element according to claim 6, in which each of the said fuel plates comprises a metallic coating on each of its faces.

8. Fuel element according to claim 1, in which the elementary fissile particles are coated fissile and fertile bodies embedded in the metallic matrix.

9. Fuel element according to claim 6, in which the fissile bodies are chosen in the group comprising uranium, plutonium and thorium.

10. Fuel element according to claim 1, in which the said fuel plates comprise first plates approximately parallel to each other and second corrugated plates arranged alternately.

11. Nuclear reactor, in which the core is formed from fuel elements according to claim 1, in which the neutron flux in the core is essentially a fast neutron flux.

12. Nuclear reactor according to claim 11, in which the gas coolant is chosen from the group comprising carbon dioxide CO₂, helium, air and argon.

13. Nuclear reactor according to claim 11, in which control devices made of boron carbide B₄C can be inserted between the fuel elements.
